(19) United States
(12) Patent Application Publication
(10) Pub. No.: US 2019/0357589 A1
(43) Pub. Date: Nov. 28, 2019

(54) COFFEE FRUIT COMPOSITIONS AND METHODS OF PRODUCTION

(71) Applicant: Charles E. VONDERACH, Livermore, CA (US)

(72) Inventor: Charles E. VONDERACH, Livermore, CA (US)

(21) Appl. No.: 16/537,561

(22) Filed: Aug. 10, 2019

Related U.S. Application Data
(63) Continuation of application No. PCT/US2018/043202, filed on Jul. 21, 2018.
(60) Provisional application No. 62/535,565, filed on Jul. 21, 2017.

(51) Int. Cl. A24B 15/16; A23F 5/02; A24B 15/28

(52) U.S. Cl. CPC A24B 15/16; A24B 15/28; A23F 5/02

(57) ABSTRACT

Compositions comprising a natural, non-ingestible processed coffee fruit material, optionally flavored with natural ingredients, and in a form that may be placed in the mouth of a user are provided. Such compositions enable the delivery of caffeine, antioxidants, coffee flavor, and/or other flavors from the coffee fruit to the user in a convenient, enjoyable, and discrete manner. The compositions provide the benefits of a coffee-based beverage in situations where it would be impractical or inappropriate for the user to consume a liquid beverage. They also provide an alternative to unhealthy non-ingestible products, such as smokeless tobacco products. Also provided are methods of manufacturing the disclosed compositions and packaged consumer products containing the compositions.

### CROSS-REFERENCE TO RELATED APPLICATION

This application claims the benefit of U.S. Provisional Application No. 62/535,565, filed on Jul. 21, 2017, the disclosure of which is incorporated herein by reference in its entirety.

### BACKGROUND OF THE INVENTION

Cigarette smoking continues to be a leading cause of preventable death, both in the United States and throughout the world. Indeed, cigarette smoking is believed to result in nearly 6 million deaths a year worldwide, and it is additionally believed to compromise the health of even larger numbers of individuals, either directly or through exposure of the individuals to secondhand smoke.

The use of smokeless tobacco, for example chewing tobacco, snuff, or snus, has been considered to be a safer alternative to cigarette smoking, although the health advantages are not entirely clear. For example, it has been estimated that the use of smokeless tobacco caused roughly 250,000 deaths per year worldwide. The impacts of smokeless tobacco on health include deaths from heart disease, as well as cancers of the mouth, pharynx, and esophagus. Use of smokeless tobacco may also harm the dental health of a user. Unlike smoke-producing products, the health impacts of smokeless tobacco are generally assumed to be limited to the user of the product, although smokeless tobacco users typically generate tobacco-contaminated saliva that is unsightly, unsanitary, and must be collected and disposed of.

Technological improvements in the production and formulation of smokeless tobacco have been reported. For example, PCT International Publication No. 2005/046363 A2 reports tobacco compositions that are readily disintegrable in the mouth. In addition to tobacco, such compositions may further include water soluble polymers, flavors, sweeteners, fiber, plasticizers, surfactants, starch, lubricants, and the like.

American consumption of smokeless tobacco is growing while cigarette smoking is declining. Awareness of the potential health risks of tobacco use, whether through smoking, third-party ingestion of secondhand smoke, or use of smokeless tobacco, has incentivized the development of alternatives to smokeless tobacco that do not have health risks and that may, in fact, present health benefits.

Many tobacco users would take advantage of alternatives to tobacco use. UST Inc., a holding company for U.S. Smokeless Tobacco Company, estimates that over half of smokers in the U.S. are seeking smoking alternatives, and with the advent of a ban on the use of all tobacco products, even smokeless tobacco, by professional baseball organizations, many tobacco users are seeking alternatives. Regardless, use of smokeless tobacco has a level of social opprobrium associated with the spitting and/or removal of the product from the mouth after use that is unsightly and unappealing.

Coffee is another widely-consumed product that is prepared from the roasted seeds (also known as “beans”) of the coffee plant, for example from Coffea Arabica. Although some individuals can be sensitive to caffeine, a stimulant compound that is present at various levels in coffee beans, most medical authorities consider coffee and coffee-containing beverages to be healthy products, particularly when consumed in moderation. Coffee and coffee-based consumable products are clearly considered more beneficial and culturally acceptable than any type of tobacco product, whether smokeable or smokeless.

Coffee beans are prepared from the fruit of the coffee plant (also known as the “cherry”), which is harvested from the coffee plant when ripe, typically by hand. Coffee beans are separated from the surrounding material of the coffee fruit either by a “wet” process, in which the flesh of the fruit is physically separated from the seeds, and the seeds are then soaked in water to soften the sticky pulp or “mucilage” that remains associated to the seed, or by a “dry” process, in which the fruit is slowly dried in the sun prior to physical hulling to remove the outer layers of the dried fruit. In either case, the coffee beans obtained from the process, known as “green” coffee beans, are processed further, including a roasting step, prior to use in preparing coffee beverages and other coffee-based products.

Although the non-bean portion of the coffee fruit is typically considered to be a wasteful by-product of the coffee production process, it has recently been attracting attention as a source of beneficial agents for human consumption. The residue of coffee fruit processing is thought to be particularly rich in antioxidants and polyphenols, including proanthocyanidins, ferulic acid, quinic acid, caffeic acid, various other chlorogenic acids, and the like. Consumption of such materials is believed to have beneficial effects on health.

Beverages containing coffee fruit have been promoted as rich sources of antioxidants (see, e.g., www.drinkbai.com). The preparation and use of extracts and powders containing coffee fruit for nutritional and cosmetic uses has also been reported recently. See, e.g., PCT International Publication No. WO 2017/040810 A1. See also, e.g., U.S. Patent Publication No. 2016/0165934 A1. The reported use of coffee fruit in consumable products has been limited to ingestible food products, however, and products containing coffee fruit have to date not been adapted as a substitute for non-ingestible, non-food products, such as smokeless tobacco products.

Direct and indirect exposure to tobacco products is known to have significant detrimental effects on health. There is thus a need to develop alternatives to currently available smokeable and smokeless tobacco products, in particular products not containing tobacco, such as the compositions disclosed herein, and their methods of production.

### SUMMARY OF THE INVENTION

The present disclosure addresses these and other needs by providing in one aspect compositions comprising:

a non-ingestible processed coffee fruit material;
wherein the composition is configured for placement a user's mouth.

In some embodiments, the processed coffee fruit material is a de-beaned coffee fruit, for example de-beaned coffee fruit comprising skin, pulp, or mucilage, de-beaned coffee fruit that is at least partially dried, or de-beaned coffee fruit that is shredded or chopped. In some embodiments, the composition is configured to deliver caffeine or an antioxidant to the user's mouth. In some embodiments, the composition is configured for placement in a buccal cavity, on a palate, or in a lingual space. In some embodiments, the composition is configured to be chewable. In some embodiments, the composition is configured as a film, for example a slow disintegrating film or a chewable film. In other embodiments, the composition is configured as a tab, for example a slow disintegrating tab or a chewable tab.

In some embodiments, the composition further comprises a flavoring agent, such as, for example, licorice, clove, menthol, aniseed, cinnamon, wintergreen, cherry, blueberry, blackberry, raspberry, apple, peach, spearmint, peppermint, lavender, cardamom, nutmeg, geranium, honey, rose, vanilla, lemon, orange, lime, cassia, caraway, jasmine, sage, fennel, ginger, anise, coriander, mint oil, or mint leaves. In specific embodiments, the flavoring agent comprises minced mint leaves.

In some embodiments, the composition further comprises a sweetener, such as, for example, sucrose, glucose, fructose, corn syrup, erythritol, isomalt, xylitol, maltitol, mannitol, sorbitol, lactitol, aspartame, acesulfame potassium, saccharine, sucralose, neohesperidine, or dihydrichalcone.

In some embodiments, the composition does not dissolve in the mouth in less than 10 minutes.

In another aspect are provided methods of manufacturing a composition comprising a non-ingestible processed coffee fruit material, comprising the steps of:

providing a coffee fruit material; and

processing the coffee fruit material;

wherein the processed coffee fruit material is non-ingestible and is configured for placement in a user's mouth.

In yet another aspect are provided packaged coffee fruit products comprising any of the compositions described herein.

### DETAILED DESCRIPTION OF THE INVENTION

The instant disclosure provides compositions, methods of manufacturing, and packaged products relating to a non-ingestible processed coffee fruit material, wherein the composition is configured for placement a user's mouth. The disclosed compositions can be used, for example, as a healthier alternative to smokeless tobacco products. In addition, the compositions can be used as an alternative to the consumption of coffee-based beverages where it would be inconvenient or inappropriate for the consumption of such a beverage.

Specifically, the use of a coffee fruit-based material has many positive benefits over tobacco use. It is not addictive, does not have health risks, unlike nicotine which is a depressant or relaxant, caffeine is a stimulant and most importantly the coffee fruit has 30-40 times the antioxidant benefit of “super fruits” like Acai and Pomegranate per gram (measured with ORAC [Oxygen Radical Absorbance Capacity] and bioavailable standards). Also, on removal from the mouth, the byproduct is a non-toxic biodegradable expended coffee fruit which is significantly less unsightly and revolting than smokeless tobacco products after their use.

### Compositions

The instant disclosure therefore provides in one aspect compositions comprising a non-ingestible processed coffee fruit material. The compositions are preferably configured for placement in a user's mouth and can therefore serve as a benign or even beneficial substitute for any of the smokeless tobacco products described above. By non-ingestible is meant that the compositions are not intended for consumption or other systemic usage. For example, the compositions are not meant to be swallowed or ingested in any other way, except for the minimal ingestion which may occur as the composition is held in the mouth during usage.

The coffee fruit material of the instant compositions is obtained from a coffee plant, typically of the genus Coffea. Coffee plants may, for example be chosen from the species Coffea arabica, Coffea canephora, and the like. Preferably the coffee fruit is allowed to ripen prior to harvest.

The coffee fruit material of the instant compositions is a processed coffee fruit material. The processing typically involves at least the traditional wet or dry processing steps used to separate the coffee beans from the coffee fruit. In other words, the processed coffee fruit material of the instant compositions can be prepared from the material normally considered a “waste” product of the typical coffee production process. Preferably the processed coffee fruit material is therefore a de-beaned coffee fruit. In specific embodiments, the de-beaned coffee fruit comprises skin, pulp, or mucilage.

In some embodiments, the de-beaned coffee fruit is at least partially dried following its separation from the coffee beans. This step is of particular utility in the case of coffee fruit obtained from a wet-processed material, where the drying step can significantly improve the stability of the processed coffee fruit material and thus enable longer-term storage. For example, a drying or partial drying of the coffee fruit material can prevent spoilage of the material that would otherwise occur due the presence of mold, fungi, bacteria, and the like, which is present particularly in damp material. A drying or partial drying of the coffee fruit material also minimizes oxidative degradation of the processed coffee fruit following its separation from the coffee beans. This step therefore maximizes the levels of antioxidants and other beneficial agents in the de-beaned fruit. Furthermore, drying or partial drying of the processed coffee fruit material helps to retain the natural flavors of the processed coffee fruit material during storage. The coffee fruit material is therefore optionally dried or partially dried as part of the processing. It should be understood that any type of processed coffee fruit material can be dried or partially dried, whether the material is obtained from a traditional wet, dry, or semi-dry de-beaning process. The material may, for example, be sun dried, convection dried, freeze dried, microwave dried, drum dried, shelf dried, or the like.

In some embodiments, the coffee fruit material is shredded, chopped, sliced, or otherwise cut, either as part of the traditional processing to remove the bean from the fruit or as a specific additional step during the manufacture of the instant compositions. In preferred embodiments, the additional shredding, chopping, slicing, or cutting of the coffee fruit material enables the comfortable placement of the material in a user's mouth. In addition, this further processing may facilitate the extraction of beneficial agents, such as caffeine, antioxidants, polyphenols, and the like, in the user's mouth, for example by chewing.

As just mentioned, in some embodiments, the compositions of the instant disclosure are configured to deliver caffeine, an antioxidant, or another active agent to a user's mouth. For example, the compositions of the instant disclosure can be configured for placement in a buccal cavity, on a palate, or in a lingual or sub-lingual space. As is well known in the pharmaceutical arts, oral administration of pharmaceutical agents can be a highly effective method for the delivery an active agent to an individual in need of treatment. For example, slow release formulations, such as sub-lingual tablets, can be placed under a user's tongue to enable absorption of the active agent directly into the bloodstream through the oral mucosa. Such formulations may reduce the time needed for the drug to enter the bloodstream and may increase the bioavailability of the drug. Delivery of active agents through the oral mucosa also limits exposure of the agent to the gastric system and may therefore be preferable for delivery of agents not stable to such environments. In some embodiments, the compositions of the instant disclosure are configured to deliver pleasing flavors to the user's mouth. The flavors may arise either from the inherent flavor of the coffee fruit material itself or from flavoring agents added to the compositions in addition to the coffee fruit material.

The caffeine, antioxidant, or other beneficial agent, including flavoring agents, of the instant compositions may be added to the composition as a separate component from the coffee fruit material. Preferably, however, the caffeine, antioxidant, or other active agent is naturally present in the coffee fruit material itself. As mentioned above, coffee fruit is known to have high levels of such agents and can therefore serve as a delivery vehicle for ingestion of those agents, even in the absence of ingestion of the coffee fruit material itself.

Without intending to be bound by theory, it is believed that the processing of the coffee fruit material, for example by the wet or dry processing steps used to separate coffee beans from the fruit, and optionally by further shredding or chopping of the coffee fruit material, increases the bioavailability of caffeine, antioxidants, and other beneficial agents in the coffee fruit, including flavoring agents.

In some embodiments, the compositions of the instant disclosure are configured to be chewable. The manufacture of chewing gum and other such non-ingestible chewable substances, as well as excipients and additives suitable for use in such products, are well-known to those of ordinary skill in the art. See, for example, PCT International Publication No. WO03/084338, including references cited therein. Accordingly, the instant compositions may include components traditionally used to formulate chewing gum compositions, including without limitation gum base, sweeteners, glycerine, softeners or plasticizers, flavoring agents, colors, and/or coatings. Gum bases may be of any conventional nature known in the art such as, e.g., a gum base of natural or synthetic origin available from a commercial source. Natural gum bases include e.g. chicle, jelutong gum, lechi de caspi gum, soh gum, siak gum, katiau gum, sorwa gum, balata gum, pendare gum, malaya gum and peach gum, natural rubbers and natural resins such as dammar and mastix. Synthetic gum bases include synthetic rubbers, paraffin, petroleum waxes, and various polymers.

Natural sweeteners usefully added to the instant compositions include, for example, sucrose, glucose, fructose, corn syrup, erythritol, isomalt, xylitol, maltitol, mannitol, sorbitol, and lactitol. Artificial sweeteners include, for example, aspartame, acesulfame potassium, saccharine, sucralose, neohesperidine, and dihydrichalcone. Glycerine may be optionally added to the compositions to maintain moistness.

As mentioned above, the instant compositions optionally comprise one or more flavoring agents. Preferably the flavoring agent comprises licorice, clove, menthol, aniseed, cinnamon, wintergreen, cherry, blueberry, blackberry, raspberry, apple, peach, spearmint, peppermint, lavender, cardamom, nutmeg, geranium, honey, rose, vanilla, lemon, orange, lime, cassia, caraway, jasmine, sage, fennel, ginger, anise, coriander, mint oil, or mint leaves. More preferably the flavoring agent comprises mint leaves, in particular chopped, shredded, or minced mint leaves.

The compositions of the instant disclosure can additionally and optionally comprise one or more botanical agents. Exemplary botanical agents suitable for inclusion in the instant compositions are described in U.S. Patent Application Publication No. 2015/0068544 A1. In some cases, these botanical agents provide beneficial properties in addition to their flavor. For example, the botanical agents may display antioxidant characteristics or provide other advantageous features.

The compositions of the instant disclosure can still further comprise an optional preservative, including a natural or artificial preservative. Such preservatives are included in the compositions in order to minimize degradation of the product, for example by bacteria or other microorganisms, or by oxidation.

Preferable preservatives for use in the instant compositions have been approved by governmental authorities for use as a food additive in the relevant jurisdiction. Exemplary preservatives usefully included within the instant compositions include sorbates, benzoates, sulphites, phenols, formates, nitrates, acetates, lactates, and propionates. Exemplary anti-oxidants and acidity regulators usefully included within the instant compositions include ascorbates, tocopherol, gallates and erythorbates, lactates, citrates and tartrates, phosphates, malates and adipates, and succinates and fumarates.

Other exemplary preservatives include chloride salts, such as calcium chloride; sulfite salts, such as sodium metabisulphate, potassium metabisulphite, sodium bisulphite, sodium disulphite, and calcium bisulphite; metal ion sequestrants, such as metal acid polyphosphate; organic anti-oxidants, such as α-tocopherol and its variants; low molecular weight organic acids, such as citric acid, malic acid, acetic acid, lactic and ascorbic acid; metal and ammonium salts of the organic acids, such as Ca, Mg, Zn, Sn, Sr, Li, Ba, Al, Cu, Mn, Na, K, and Fe salts; film forming agents, such as waxes, gums, polysaccharides (including hydroxymethyl cellulose, methyl cellulose, and microcrystalline cellulose), alginates, carrageenans, lipids, pectins, modified starches, locust bean gum, xanthum gum, gellan gum, guar gum, and tragacanths. In some embodiments, the compositions comprise more than one preservative. In some embodiments, the preservative is a soluble preservative, for example an aqueous preservative, and in other embodiments, the preservative is a volatile preservative, for example a gaseous or vapor preservative agent.

In some embodiments, the compositions of the instant disclosure are configured as a film or a tab, including a slow disintegrating film or a slow disintegrating tab. The formulation of oral films and tabs is well understood in the pharmaceutical arts. Such films and tabs can contain, for example, film-forming agents such as porcine gelatin, pullulan, carrageenan, pectin, locust bean gum, or xanthan gum. The films can alternatively, or in addition, contain film-forming polymers, such as, for example, carbomer, carboxymethylcellulose, cellulose acetate, cellulose acetate phthalate, ethylcellulose, hydroxyethyl cellulose, hydroxypropyl cellulose, hydroxypropyl methylcellulose, hydroxypropyl methylcellulose phthalate, methylcellulose, polymethacrylates, polyvinyl alcohol, povidone, shellac, a fatty substance e.g. hard fat, hydrogenated cottonseed oil, hydrogenated vegetable oil, a polyethylene glycol, a polyethylene oxide, a wax, a zein, a sugar or derivative of a sugar, e.g. glucose, maltodextrin, polydextrose, sucrose, lactose, alginic acid, carrageenan, sugar alcohols or derivatives of sugar alcohols, e.g. mannitol, maltitol, isomalt, xylitol, sorbitol, and so forth. The films and tabs can be configured, for example, as chewable films or chewable tabs. Exemplary films and tabs suitable for use in tobacco-containing compositions are described, for example, in PCT International Publication No. WO 2005/046363 A2. Similar formulations can be adapted for use in the coffee fruit-containing compositions of the instant disclosure, as would be understood by those of ordinary skill in the art.

### Methods of Manufacturing

In another aspect, the instant disclosure provides methods of manufacturing the above-described compositions and others. In particular, the disclosure provides methods of manufacturing a composition comprising a non-ingestible processed coffee fruit material, comprising the steps of:
providing a coffee fruit material; and
processing the coffee fruit material;
   wherein the processed coffee fruit material is non-ingestible and is configured for placement in a user's mouth.

In specific embodiments, the coffee fruit material is a de-beaned coffee fruit. In more specific embodiments, the de-beaned coffee fruit comprises skin, pulp, or mucilage. In other more specific embodiments, the de-beaned coffee fruit is at least partially dried. In still other more specific embodiments, the de-beaned coffee fruit is shredded or chopped.

The coffee fruit material of the instant methods is preferably spray moistened, most preferably with water or another suitable liquid, either prior to processing or during processing, in order to provide the best texture of the resulting composition.

The instant methods of manufacturing may optionally comprise the further step of combining the coffee fruit material with a flavoring agent. The flavoring agent may be combined with the coffee fruit material either before, after, or during the processing step. For example, the coffee fruit material and the flavoring agent may be separately shredded or chopped, and the separately prepared components subsequently combined. Alternatively, unprocessed coffee fruit material and flavoring agent may be combined prior to processing, for example by shredding or chopping of the combined materials.

It should be understood that the above steps result in a processed coffee fruit material that is non-ingestible. In other words, the resultant processed material is not intended to be swallowed or otherwise ingested by the user upon placement in the user's mouth. Instead, the processed material is held in the user's mouth for a period of time that allows soluble agents in the material, for example caffeine, antioxidants, and/or intrinsic or extrinsic flavoring or other agents to be released into the user's mouth. Use of the compositions produced by these methods is thus analogous to the use of smokeless tobacco products, and the compositions can thereby serve as a healthy alternative to such products. The coffee fruit material should accordingly not be processed so finely that the user is likely to swallow or otherwise ingest the processed material. At the same time, however, the processed material needs to be small enough for placement in the user's mouth. Those of ordinary skill in the art of food processing will understand the extent of shredding, chopping, or other processing suitable to achieve the desired properties in a user's mouth.

### Packaged Coffee Fruit Products

In yet another aspect, the instant disclosure provides packaged coffee fruit products according to the above description. In these embodiments, the above compositions are preferably packed into a suitable container and sealed for long-term storage. The containers are optionally refrigerated to maintain freshness of the contents.

It will be readily apparent to one of ordinary skill in the relevant arts that other suitable modifications and adaptations to the compositions, methods, and products described herein may be made without departing from the scope of the invention or any embodiment thereof.

All patents, patent publications, and other published references mentioned herein are hereby incorporated by reference in their entireties as if each had been individually and specifically incorporated by reference herein.

While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined by reference to the appended claims, along with their full scope of equivalents.

1. A composition comprising:
a non-ingestible processed coffee fruit material;
wherein the composition is configured for placement a user's mouth.

2. The composition of claim 1, wherein the processed coffee fruit material is a de-beaned coffee fruit.

3. The composition of claim 2, wherein the de-beaned coffee fruit comprises skin, pulp, or mucilage.

4. The composition of claim 2, wherein the de-beaned coffee fruit is at least partially dried.

5. The composition of claim 2, wherein the de-beaned coffee fruit is shredded or chopped.

6-7. (canceled)

8. The composition of claim 1, wherein the composition is configured for placement in a buccal cavity, on a palate, or in a lingual space.

9. The composition of claim 8, wherein the composition is configured for placement in a buccal cavity.

10. The composition of claim 1, wherein the composition is configured to be chewable.

11. The composition of claim 1, wherein the composition is configured as a film.

12. The composition of claim 11, wherein the film is a slow disintegrating film.

13. The composition of claim 11, wherein the film is a chewable film.

14. The composition of claim 1, wherein the composition is configured as a tab.

15. The composition of claim 14, wherein the tab is a slow disintegrating tab.

16. The composition of claim 14, wherein the tab is a chewable tab.

17. The composition of claim 1, wherein the composition further comprises a flavoring agent.

18. The composition of claim 17, wherein the flavoring agent comprises licorice, clove, menthol, aniseed, cinnamon, wintergreen, cherry, blueberry, blackberry, raspberry, apple, peach, spearmint, peppermint, lavender, cardamom, nutmeg, geranium, honey, rose, vanilla, lemon, orange, lime, cassia, caraway, jasmine, sage, fennel, ginger, anise, coriander, mint oil, or mint leaves.

19. (canceled)

20. The composition of claim 1, wherein the composition further comprises a sweetener.

21. The composition of claim 20, wherein the sweetener comprises sucrose, glucose, fructose, corn syrup, erythritol, isomalt, xylitol, maltitol, mannitol, sorbitol, lactitol, aspartame, acesulfame potassium, saccharine, sucralose, neohesperidine, or dihydrichalcone.

22. The composition of claim 1, wherein the composition does not dissolve in the mouth in less than 10 minutes.

23-43. (canceled)

44. A packaged coffee fruit product comprising the composition of claim 1.
